(19) United States
(12) Patent Application Publication
(10) Pub. No.: US 2020/0282648 A1
(43) Pub. Date: Sep. 10, 2020

(54) A CONTAINER TO HOLD BUILD MATERIAL FOR ADDITIVE MANUFACTURING

(71) Applicant: HEWLETT-PACKARD DEVELOPMENT COMPANY, L.P., Spring, TX (US)

(72) Inventors: Wesley R Schalk, Vancouver, WA (US); Bradley B Branham, Vancouver, WA (US); Kevin E Swier, Corvallis, OR (US)

(21) Appl. No.: 16/604,159

(22) PCT Filed: Dec. 2, 2017
(86) PCT No.: PCT/US2017/064378

§ 371 Date: Oct. 9, 2019

(51) Int. Cl. B29C 64/259; B29C 64/343; B29C 64/241

(52) U.S. Cl. CPC B29C 64/259; B33Y 30/00; B29C 64/241; B29C 64/343

(57) ABSTRACT

In one example, a replaceable cartridge to hold build material in an additive manufacturing machine includes a rigid exterior structured to fit into a receptacle in the machine, an anti-static interior to partially or fully contain an unfused build material, and an opening through which unfused build material may leave the antistatic interior.

### BACKGROUND

Additive manufacturing machines produce 3D (three-dimensional) objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices each defining that part of a layer or layers of build material to be formed into the object.

### DRAWINGS

FIGS. 1-4 illustrate one example of a build material supply cartridge for an additive manufacturing machine. FIG. 1 is an isometric showing the exterior of the example cartridge. FIG. 2 is an exploded view of the example cartridge. FIGS. 3 and 4 are partial sections viewed along the line 3-3 in FIG. 1.

FIGS. 5-7 illustrate another example of a build material supply cartridge for an additive manufacturing machine. FIG. 5 is an isometric showing the exterior of the example cartridge. FIG. 6 is a partial section viewed along the line 6-6 in FIG. 5. FIG. 7 is a partially exploded view of the example cartridge.

FIG. 8 illustrates one example of a group of build material containers for additive manufacturing.

The same part numbers designate the same or similar parts throughout the figures. The figures are not necessarily to scale.

### DESCRIPTION

In some additive manufacturing processes, powdered build materials are used to form a solid object. Particles in each of many successive layers of build material powder are thermally, chemically or otherwise fused in a desired pattern to form the object. HP Inc. has developed a new build material supply system for additive manufacturing in which replaceable build material powder supply cartridges are integrated into the additive manufacturing machine. The cartridges are oriented horizontally and rotated in the machine to move the powder to inhibit agglomeration and to dispense powder from the cartridges. Examples of the new supply system are disclosed in international patent application nos. PCT/US2017/055269 titled CHAMBER FOR STORING BUILD MATERIAL and PCT/US2017/055309 titled SUPPLY STATION FOR DISPENSING BUILD MATERIAL, both filed Oct. 5, 2017. When a cartridge is rotated the build material inside the cartridge slides along the interior surfaces of the cartridge. Friction between the build material powder and the surfaces of the cartridge may generate static electricity. A buildup of static electricity in the material in a supply cartridge creates a risk of damage due to uncontrolled discharge of the static electricity and may adversely affect the flowability of the powder.

Accordingly, new structures have been developed to inhibit static electricity forming in the build material in a supply cartridge. In one example, a supply cartridge is made of the same material as the build material contained in the cartridge or a material with a charge affinity similar to the charge affinity of the build material. Friction between the same materials or materials with a similar charge affinity is significantly less likely to generate static electricity than friction between dissimilar materials. In another example, a supply cartridge includes an anti-static interior to partially or fully contain the build material. The anti-static interior may be implemented, for example, as a liner made of the same or similar material as the build material contained in the cartridge. An anti-static liner enables the use of a less expensive exterior shell material while still inhibiting static electricity forming in the build material.

Examples are not limited to powdered build materials or build material supply cartridges. Examples may be used to help inhibit static electricity in other containers and in other forms of build materials for additive manufacturing. The examples described herein illustrate but do not limit the scope of the patent, which is defined in the Claims following this Description.

As used in this document, “and/or” means one or more of the connected things; “anti-static” means to inhibit static electricity forming in a material; and a “similar” charge affinity means±30 nC/J (nano Coloumbs per Joule).

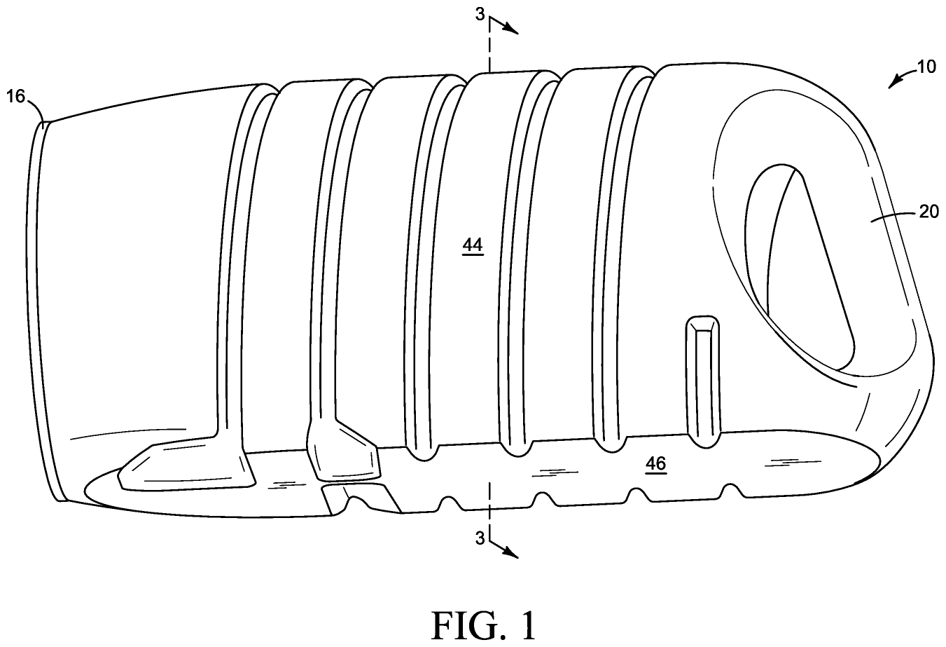

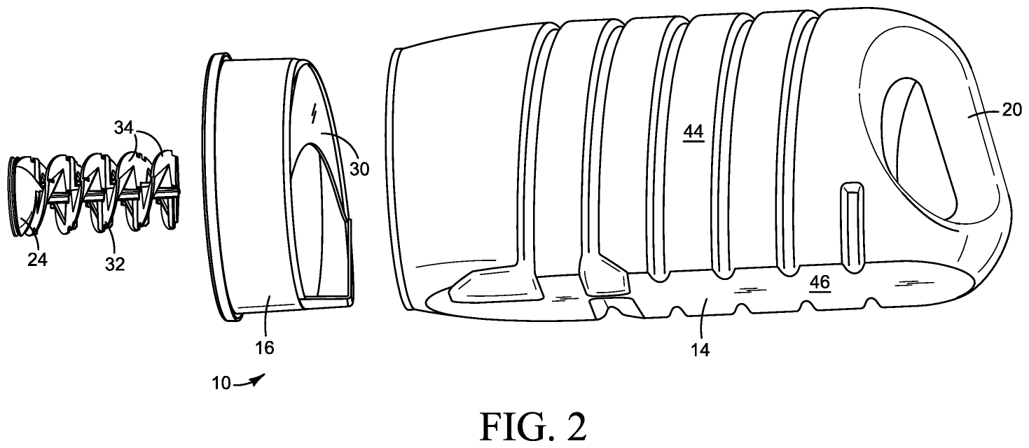

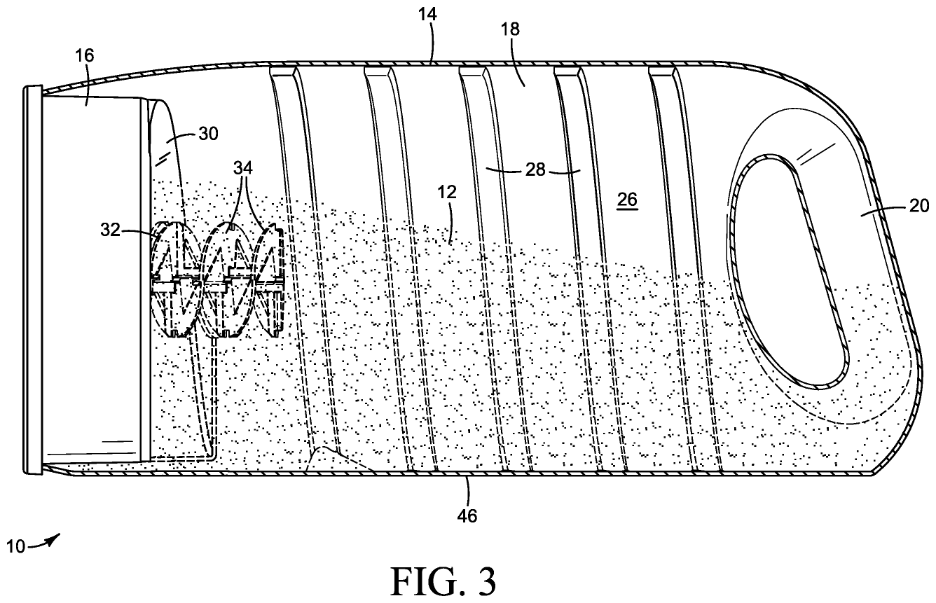

FIGS. 1-4 illustrate one example of a build material supply cartridge 10 for an additive manufacturing machine. Cartridge 10 in FIGS. 1-4 is structured to hold a powdered or other form of unfused build material 12 (FIG. 3) in a horizontal orientation so that the cartridge may be rotated in the machine to move the build material to inhibit agglomeration and to dispense build material from the cartridge. Build material 12 is depicted by stippling in the figures. Cartridge 10 includes a rigid cylindrical container 14 made of the same material, or a material with a similar charge affinity, as build material 12 contained in the cartridge. While a container 14 made of the same material as build material 12 may be used to achieve a higher degree of protection against the buildup of static electricity in a build material 12, a container 14 made of a material with a similar charge affinity to build material 12 may deliver an acceptable degree of protection against static buildup at a lower cost and/or to deliver more desirable manufacturing characteristics. Polyamide powder is a commonly used build material for additive manufacturing. Thus, for one example, container 14 is made of a polyamide for a cartridge 14 that is to contain a polyamide build material powder 12.

Friction between build material 12 and a container 14 made from the same or a similar material is significantly less likely to create static electricity than friction between build material 12 and a container made of a different material. Thus, for a supply cartridge 10 that is rotated inside the additive manufacturing machine as part of the supply process, container 14 made of the same or a similar material as build material 12 provides an anti-static interior that inhibits static electricity forming in build material 12 moving against the interior of the container.

The structural configuration and function of a build material supply cartridge like cartridge 10 shown in FIGS. 1-4 is disclosed in more detail in PCT/US2017/055269 titled CHAMBER FOR STORING BUILD MATERIAL and PCT/US2017/055309 titled SUPPLY STATION FOR DISPENSING BUILD MATERIAL, both filed Oct. 5, 2017 and incorporated herein by reference in their entirety.

Referring to FIGS. 1-4, cartridge 10 includes container 14 and a base 16 that together enclose an interior chamber 18 to hold build material 12. Container 14 may include a handle 20. Build material 12 may flow out of and/or into chamber 18 through an opening 22 in base 16. A valve 24 controls the flow of build material 12 through opening 22. The interior surface 26 of a cylindrical or barrel shaped container 14 is structured to move build material 12 axially toward or away from base 16 as cartridge 10 is rotated, depending on the direction of rotation, for example with helical raised portions 28, commonly referred as “flighting”, that auger build material 12 along the container when cartridge 10 is rotated. Base 16 is structured to move build material 12 radially toward or away from opening 22 as cartridge 10 is rotated, depending on the direction of rotation, for example with an Archimedes screw 30.

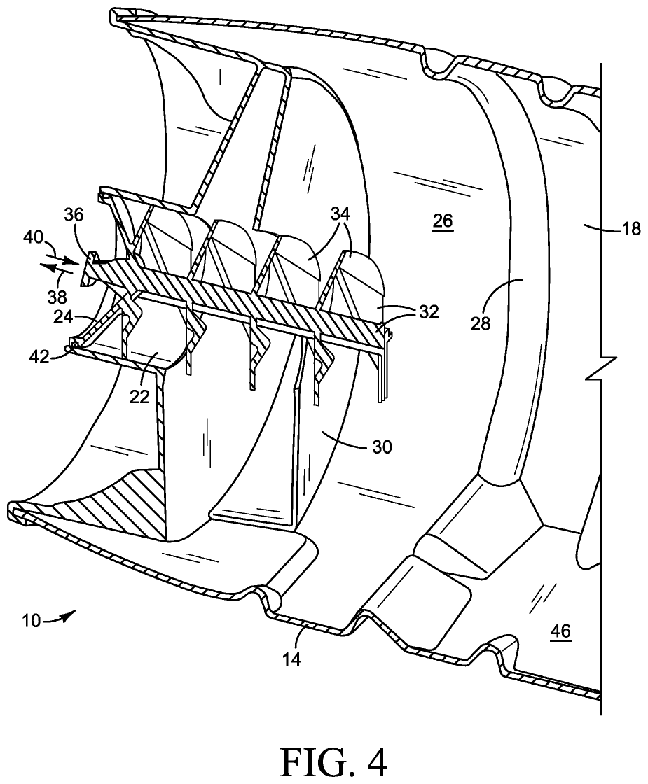

In this example, valve 24 includes an auger 32 to move build material 12 axially through opening 22. Auger 32 may include a helical blade 34 that matches the spiral of base 16 to complete Archimedes screw 30. Auger 32 is keyed to base 16 or otherwise operatively linked to container 14 so that auger 32 rotates with base 16 and container 14. As best seen in the section detail of FIG. 4, valve 24 includes an actuator pin 36 that is pulled out to open valve 24, as indicated by arrow 38, and pushed in to close valve 24, as indicated by arrow 40. Valve 24 is closed in FIG. 4. An o-ring or other suitable seal 42 may be used to seal opening 22 when valve 24 is closed. In a dispensing operation, valve 24 is opened and cartridge 10 rotated in a dispensing direction so that container flighting 28, base screw 30, and valve auger 32 move build material 12 toward and through opening 22.

Also in this example, the exterior surface 44 of container 14 includes a flat part 46. A flat part 46 may be used to orient cartridge 10 in and align it to a receiving station in an additive manufacturing machine, as well help cartridge 10 to remain stable resting on or against a flat surface.

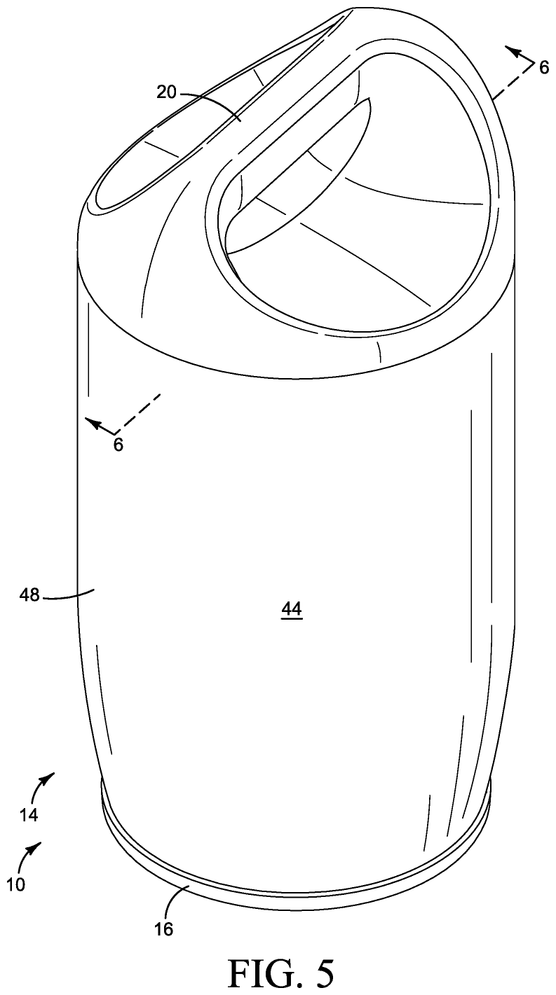

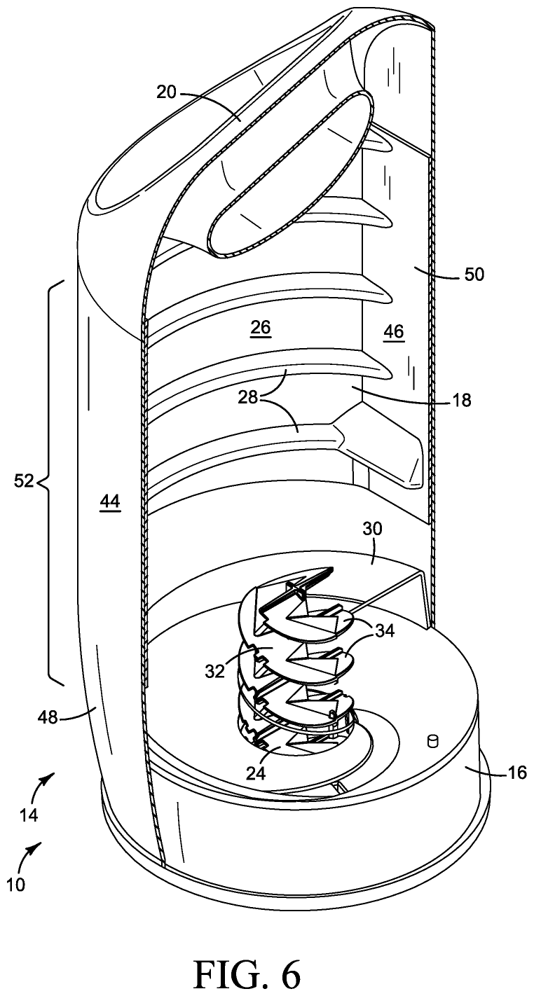

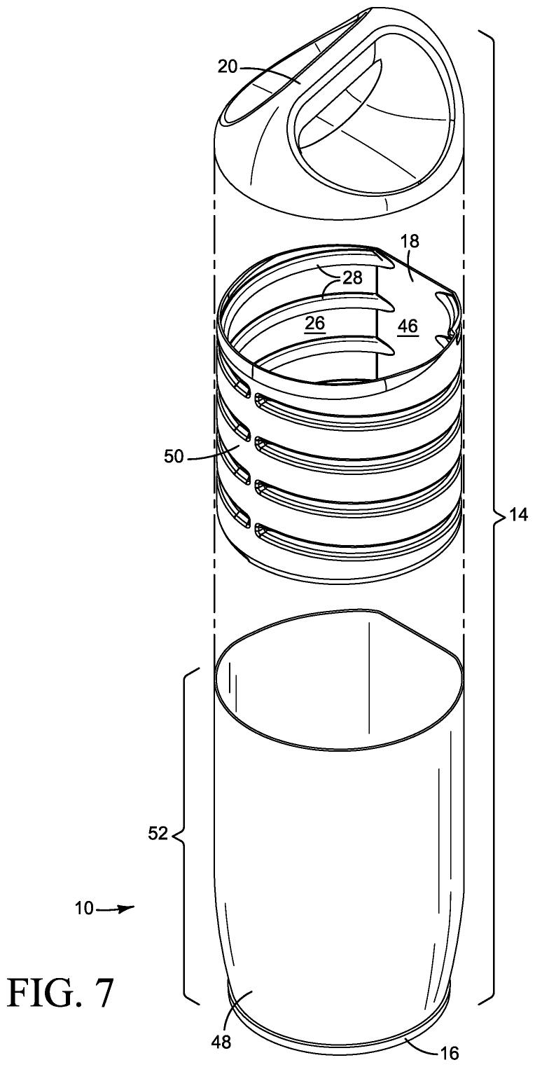

FIGS. 5-7 illustrate another example of a build material supply cartridge 10 for an additive manufacturing machine. Referring to FIGS. 5-7, cartridge 10 includes a container 14 with a shell 48 and an anti-static liner 50 that forms an interior surface 26 of container 14 along the barrel 52 of shell 48 between base 16 and handle 20. Liner 50 may be implemented, for example, as a coating on the inside of shell 48 or as an insert into shell 48. In one example, liner 50 is made of the same material as build material 12 or a material with a charge affinity similar to build material 12. A replaceable liner 50 insert may be desirable, for example, to enable the use of a single shell with multiple interchangeable liners to accommodate different types of build material and/or to replace worn or damaged liners.

Build material 12 may pass out of and/or into an interior chamber 18 through an opening 22 in base 16. A valve 24 controls the passing of build material 12 through opening 22. The interior surface 26 of liner 50 is structured to move build material 12 axially toward or away from base 16 as cartridge 10 is rotated, depending on the direction of rotation, for example with helical flighting 28. Base 16 is structured to move build material 12 radially toward or away from opening 22 as cartridge 10 is rotated, depending on the direction of rotation, for example with an Archimedes screw 30. In this example, valve 24 includes an auger 32 to move build material 12 axially through opening 22. Auger 32 may include flighting 34 that matches the spiral feature 30 of base 16 to complete an Archimedes screw 30.

Auger 32 is keyed to base 16 or otherwise operatively linked to container 14 so that auger 32 rotates with base 16 and container 14. As best seen in the section detail of FIG. 4, valve 24 includes an actuator pin 36 that is pulled out to open valve 24, as indicated by arrow 38, and pushed in to close valve 24, as indicated by arrow 40. Valve 24 is closed in FIG. 4. An o-ring or other suitable seal 42 may be used to seal opening 22 when valve 24 is closed. In a dispensing operation, valve 24 is opened and cartridge 10 rotated in a dispensing direction so that container flighting 28, base screw 30, and valve auger 32 move build material 12 toward and through opening 22. Also in this example, the exterior surface 44 of container 14 includes a flat part 46. A flat part 46 may also be used to orient cartridge 10 in and align it to a receiving station in an additive manufacturing machine, as well help cartridge 10 to remain stable resting on or against a flat surface.

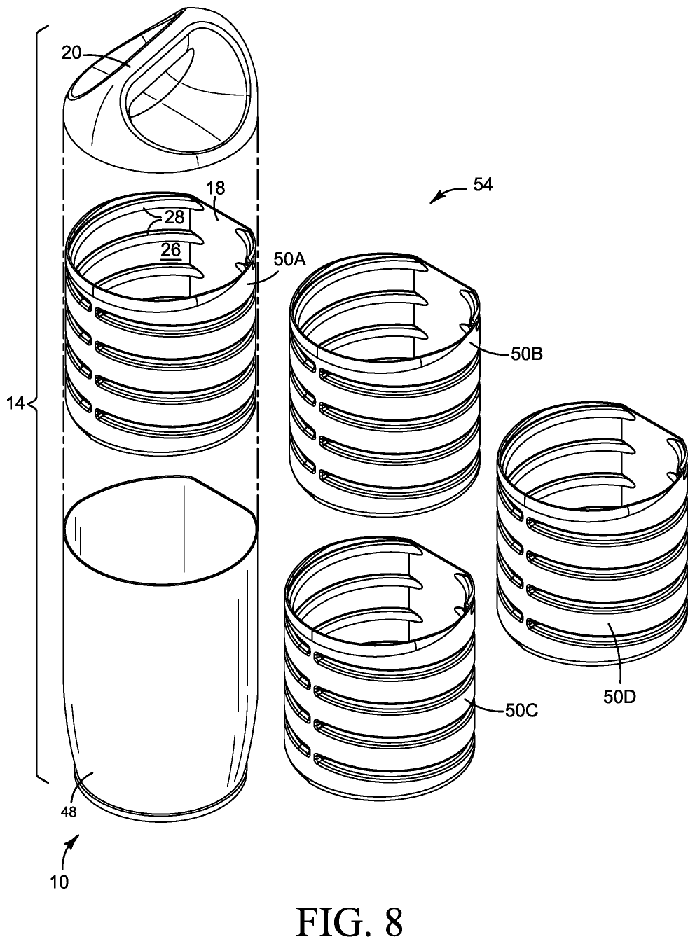

FIG. 8 illustrates a group 54 of containers 14 made up of a single shell 48 and multiple interchangeable anti-static liners 50A-50D each liner structured to inhibit static electricity forming in a corresponding different build material to be held in the container. For example, a shell 48 may be made of high density polyethylene (HDPE) and a liner 50A may be made of a polyamide for a container 14 to hold a polyamide build material, liner 50B may be made of a ceramic material for a container 14 to hold a ceramic build material, liner 50C may be made of a metal for a container 14 to hold a metal build material, and liner 50D may be made of a composite material for a container 14 to hold a composite build material. Other suitable liner materials may include polypropylene and polyoxymethylene.

As noted at the beginning of this Description, the examples shown in the figures and described above illustrate but do not limit the scope of the patent. Other examples are possible. Therefore, the foregoing description should not be construed to limit the scope of the patent, which is defined in the following Claims.

“A” and “an” as used in the Claims means one or more.

1. A replaceable cartridge to hold build material in an additive manufacturing machine, the cartridge comprising:
a rigid exterior structured to fit into a receptacle in the machine;
an anti-static interior to partially or fully contain an unfused build material; and
an opening through which unfused build material may leave the anti-static interior.

2. The cartridge of claim 1, where the anti-static interior comprises an anti-static liner.

3. The cartridge of claim 2, where the anti-static liner comprises a replaceable anti-static liner.

4. The cartridge of claim 2, where the anti-static liner comprises an anti-static coating.

5. The cartridge of claim 1, where the anti-static interior comprises the container made of anti-static material.

6. The cartridge of claim 5, where the container made of anti-static material is a container made of the same material as the build material to be contained in the cartridge.

7. The cartridge of claim 5, where the container made of anti-static material is a container made of a material with a charge affinity similar to a charge affinity of the build material to be contained in the cartridge.

8. The cartridge of claim 1, where the anti-static interior includes helical raised portions to move build material along the interior when the cartridge is rotated.

9. The cartridge of claim 2, where the anti-static liner includes helical raised portions to move build material along the interior when the cartridge is rotated.

10. The cartridge of claim 1, comprising unfused build material in the container.

11. A replaceable cartridge to hold an unfused build material in an additive manufacturing machine, the cartridge comprising:
a container having a rigid shell and a liner lining the shell to form some or all of an interior chamber to hold the unfused build material, the liner made of the same material as the build material; and
an outlet from the chamber.

12. The cartridge of claim 11, comprising a valve to control a flow of unfused build material out of the chamber.

13. A group of containers each to hold a different type of build material for additive manufacturing, the group comprising:
a single shell; and
multiple interchangeable anti-static liners to line the shell, each liner structured to inhibit static electricity forming in a corresponding different build material to be held in the shell.

14. The group of claim 13, where each liner is made of a material the same as the corresponding build material.

15. The group of claim 13, where each liner is made of a material with a charge affinity similar to a charge affinity of the corresponding build material.

16. The group of claim 13, where:
the shell is made of a high density polyethylene; and
a first one of the liners is made of a polyamide.
